(19) United States
(12) Patent Application Publication
(10) Pub. No.: US 2025/0306437 A1
(43) Pub. Date: Oct. 2, 2025

(54) MOUNTING APPARATUS AND IMAGING APPARATUS

(71) Applicant: FUJIFILM Corporation, Tokyo (JP)

(72) Inventor: Takayuki SHIMIZU, Saitama (JP)

(73) Assignee: FUJIFILM Corporation, Tokyo (JP)

(21) Appl. No.: 19/090,363

(22) Filed: Mar. 25, 2025

(30) Foreign Application Priority Data
Mar. 26, 2024 (JP) 2024-049440

(51) Int. Cl. G03B 17/14

(52) U.S. Cl. CPC G03B 17/14

(57) ABSTRACT

A locking member is rotatably supported, and in a case where the locking member is rotated in a first direction, the locking member presses a first ring member engaging with a lens barrel in an optical axis direction of the lens barrel to lock the lens barrel, and in a case where the locking member is rotated in a second direction, the pressing is released.

### CROSS-REFERENCE TO RELATED APPLICATIONS

This application claims priority under 35 U.S.C § 119 (a) to Japanese Patent Application No. 2024-049440 filed on 26 Mar. 2024. The above application is hereby expressly incorporated by reference, in its entirety, into the present application.

### BACKGROUND OF THE INVENTION

### 1. Field of the Invention

The present invention relates to a mounting apparatus and an imaging apparatus.

### 2. Description of the Related Art

JP2019-78902A (corresponding to US2020/0249550A1) discloses that, in a case where a mount adapter, to which an interchangeable lens is coupled, is coupled to a camera body, a gripping portion of a lens mount provided in the camera body is rotationally moved to engage a mount claw portion of the lens mount with a first mount claw portion provided at one end portion of a movable barrel of the mount adapter attached to the lens mount.

JP2015-60076A describes that, in a case where an interchangeable lens is attached to a lens mount, a bayonet claw portion on a lens mount side and a lens bayonet claw portion abut each other by rotating a lever, so that the interchangeable lens is attached to the lens mount.

JP2020-118774A discloses that, in a case where an optical device such as a lens device is attached to a camera 4, a lens mount is inserted into a camera mount, and pressing means on an optical device side is moved in the optical axis direction, so that the optical device is subjected to pressure-welding against a subject-side surface of the camera.

### SUMMARY OF THE INVENTION

An object of the present invention is to provide a mounting apparatus and an imaging apparatus capable of suppressing a force that causes an accessory device to be pulled out from the imaging apparatus and reinforce engagement of the accessory device with the imaging apparatus even in a case where a large-sized accessory device having a large mass, a long total length, and the like is mounted on the imaging apparatus.

A mounting apparatus according to an aspect of the present invention comprises a fixing member, a first ring member that engages with an accessory device in a case where the accessory device is mounted, and a locking member that is rotatably supported, presses the first ring member engaging with the accessory device in an optical axis direction of the accessory device to lock the accessory device in a case where the locking member is rotated in a first direction, and releases the pressing in a case where the locking member is rotated in a second direction.

It is preferable that the first ring member includes a plurality of first inclined surface portions of which thicknesses in the optical axis direction change, the locking member includes a plurality of second inclined surface portions of which thicknesses in the optical axis direction change, and in a case where the locking member is rotated in the first direction, the second inclined surface portion overlaps the first inclined surface portion along a radial direction of the locking member, so that the locking member is pressed in the optical axis direction.

It is preferable that each of the first inclined surface portion and the second inclined surface portion is provided at three locations. It is preferable that, in a case where the locking member is rotated in the first direction, a start point portion of the second inclined surface portion rotates while pressing the first inclined surface portion of which the thickness increases as the first inclined surface portion extends to the first direction.

It is preferable that the first ring member includes a plurality of engaging portions engaging with the accessory device, and the engaging portion presses the accessory device by the pressing of the locking member against the first ring member.

It is preferable that a biasing portion that biases the accessory device engaging with the first ring member is provided, in which the biasing portion is provided between a plurality of first inclined surface portions that are provided in the first ring member and of which thicknesses in the optical axis direction change.

It is preferable that a second ring member that includes a coupling portion for coupling the first ring member to be movable in the optical axis direction and coupling the locking member to be rotatable is provided, in which the second ring member is fastened to the fixing member by a fastening member, the first ring member includes a plurality of first inclined surface portions of which thicknesses in the optical axis direction change from a start point portion to an end point portion, and an angle formed by the coupling portion and the end point portion of the first inclined surface portion is within 15°.

It is preferable that a second ring member that includes a coupling portion for coupling the first ring member to be movable in the optical axis direction and coupling the locking member to be rotatable is provided, in which an insertion hole into which the coupling portion is inserted is formed in the locking member along a radial direction of the locking member. It is preferable that the insertion hole is formed such that a stroke of the locking member in the radial direction is within 40°.

It is preferable that a pin member that is movable in the optical axis direction and engages with the accessory device is provided. It is preferable that a second ring member that includes a coupling portion for coupling the first ring member to be movable in the optical axis direction and coupling the locking member to be rotatable is provided, in which an insertion hole into which the pin member and the coupling portion is inserted is formed in the locking member along a radial direction of the locking member. An imaging apparatus comprising the mounting apparatus according to the embodiment of the present invention.

According to the present invention, it is possible to suppress a force that causes an accessory device to be pulled out from the imaging apparatus and reinforce engagement of the accessory device with the imaging apparatus even in a case where a large-sized accessory device having a large mass, a long total length, and the like is mounted on the imaging apparatus.

### BRIEF DESCRIPTION OF THE DRAWINGS

FIG. 1 is a perspective view showing a digital camera and a lens barrel.

FIG. 2 is a perspective view showing a mounting apparatus.

FIG. 3 is a partially cross-sectional view of the mounting apparatus.

FIG. 4 is an exploded perspective view of a first ring member, a locking member, and a second ring member.

FIG. 5 is a perspective view of the first ring member.

FIG. 6 is an explanatory view showing a first inclined surface portion.

FIG. 7 is a perspective view of the locking member.

FIG. 8 is an explanatory view showing a second inclined surface portion.

FIG. 9 is an explanatory view showing movement of the first ring member in an optical axis direction in a case where the locking member is rotated in a first direction.

FIG. 10 is an explanatory view showing movement of the first ring member in the optical axis direction in a case where the locking member is rotated in a second direction.

FIG. 11 is a perspective view of a biasing ring.

FIG. 12 is a perspective view of the first ring member and the biasing ring.

FIG. 13 is an explanatory view showing an angle θ1.

FIG. 14 is an explanatory view showing a stroke θ2.

### DESCRIPTION OF THE PREFERRED EMBODIMENTS

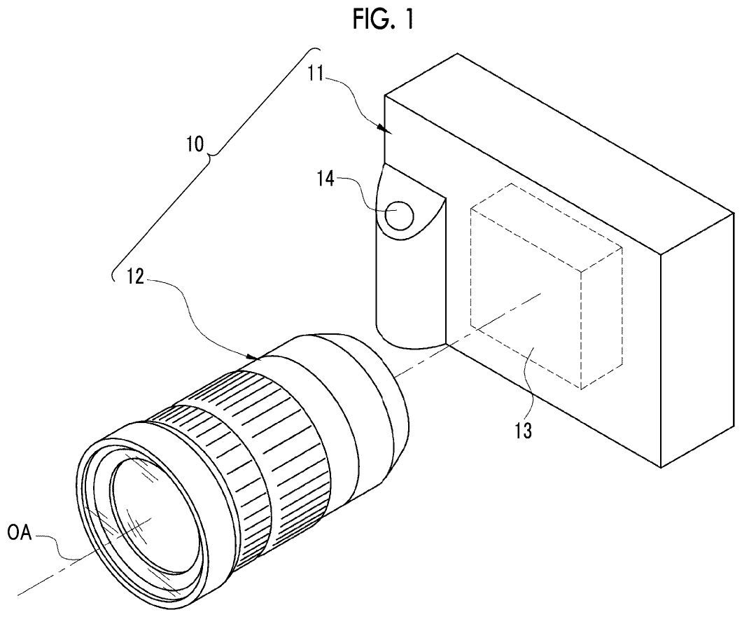

As shown in FIG. 1, a digital camera 10 is an imaging apparatus for capturing a subject, and comprises a camera body 11 and an interchangeable lens barrel 12. A mounting apparatus 13, a release switch 14, a power switch (not shown), and the like are provided on a front surface of the camera body 11. The lens barrel 12 is attachably and detachably mounted on the mounting apparatus 13.

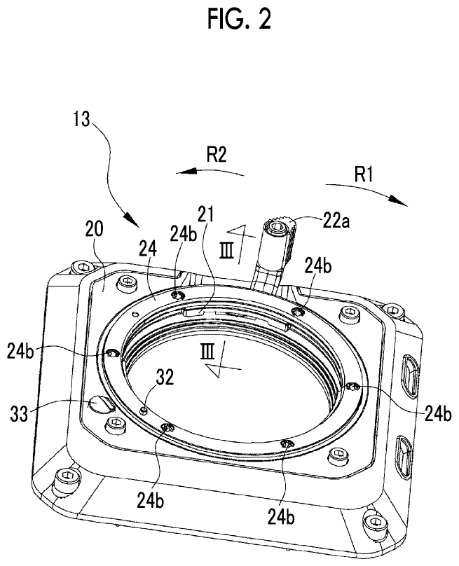

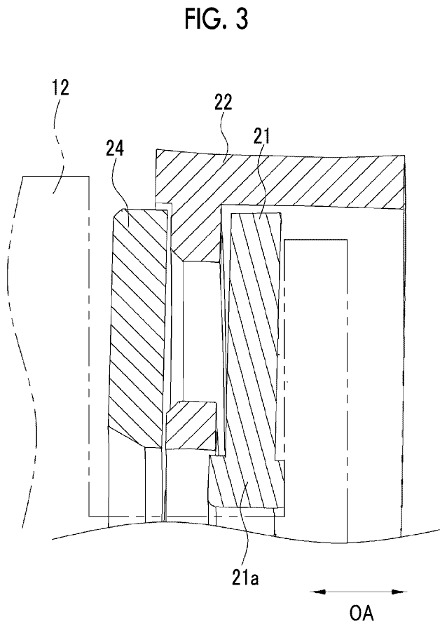

As shown in FIGS. 2 and 3, the mounting apparatus 13 comprises a fixing member 20 that is fixed to the camera body 11, a first ring member 21, and a locking member 22. The first ring member 21 engages with the lens barrel 12 in a case where the lens barrel 12 is mounted. In the first ring member 21, three bayonet claws 21a are provided at intervals of 120° as engaging portions that engage with the lens barrel 12.

The locking member 22 is rotatably supported with respect to the fixing member 20 and functions as a locking member that locks the lens barrel 12 engaging with the first ring member 21. In a case where the locking member 22 is rotated in a clockwise first direction R1, the first ring member 21 that engages with the lens barrel 12 is pressed in an optical axis direction OA of the lens barrel to lock the lens barrel 12. On the other hand, in a case where the locking member 22 is rotated in the counterclockwise second direction R2, the pressing against the first ring member 21 is released. The locking member 22 is provided with a rotary lever 22a for rotating the locking member 22 in the first direction R1 or the second direction R2.

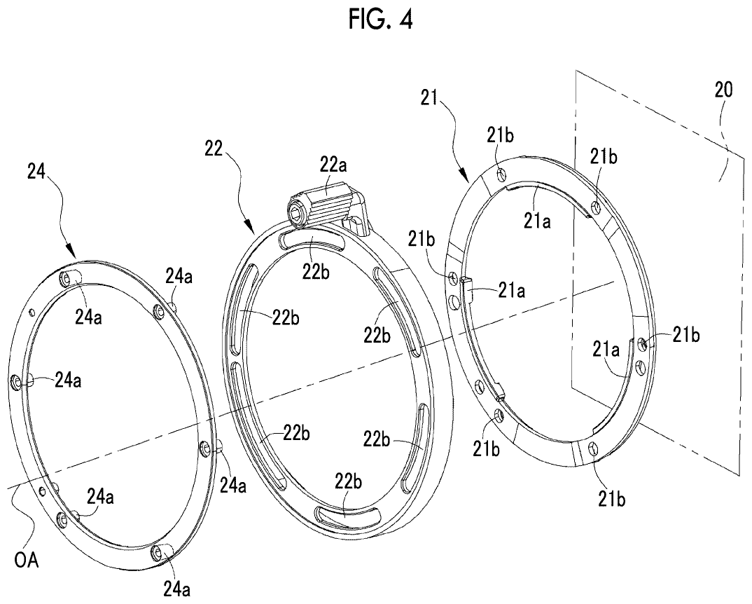

As shown in FIG. 4, the mounting apparatus 13 comprises a second ring member 24 having a coupling portion 24a for coupling the first ring member 21 to be movable in the optical axis direction OA and coupling the locking member 22 to be rotatable. The coupling portion 24a is a boss or the like, and six coupling portions 24a are provided. The coupling portion 24a is inserted into each of an insertion hole 22b of the locking member 22 and an insertion hole 21b of the first ring member 21 in this order. In this state, the second ring member 24 is fastened to the fixing member 20 by screwing a screw 24b (see FIG. 2), which is a fastening member, with respect to the coupling portion 24a.

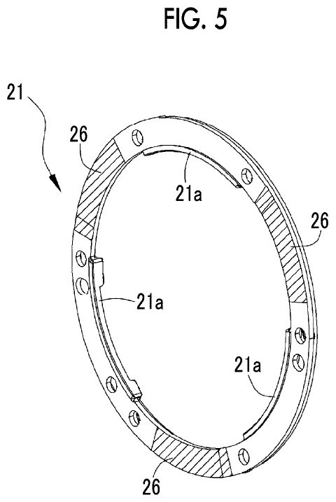

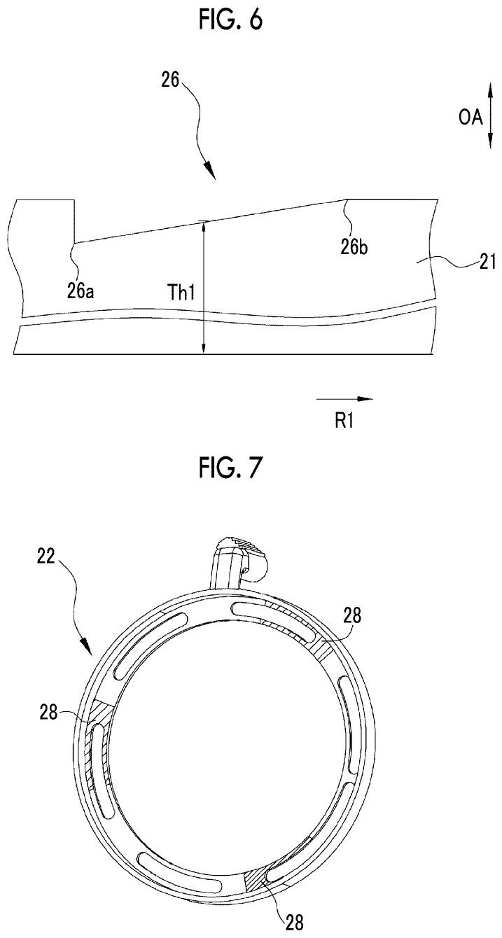

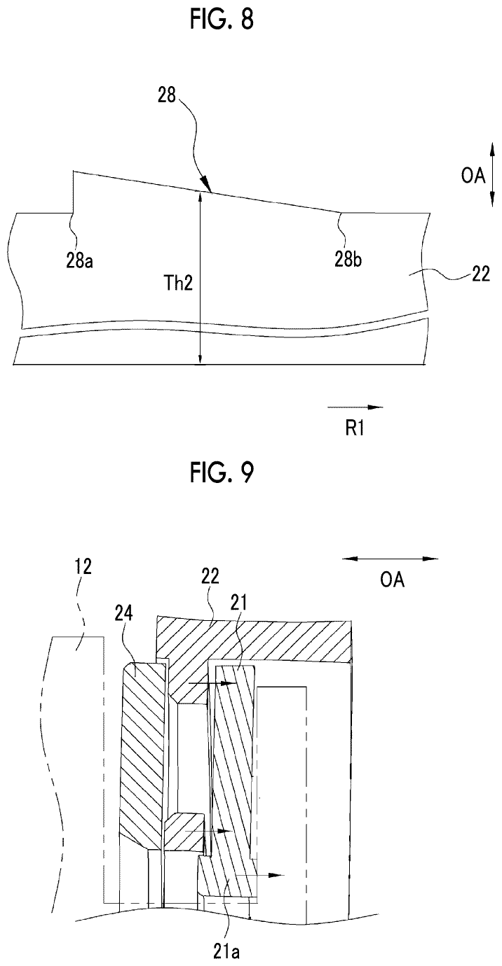

As shown in FIG. 5, three first inclined surface portions 26 are provided at intervals of 120° in the first ring member 21. As shown in FIG. 6, in the first inclined surface portion 26, a thickness Th1 in the optical axis direction OA changes from a start point portion 26a to an end point portion 26b. The thickness Th1 of the first inclined surface portion 26 increases as the first inclined surface portion 26 extends to the first direction R1. As shown in FIG. 7, three second inclined surface portions 28 are provided at intervals of 120° in the locking member 22. As shown in FIG. 8, in the second inclined surface portion 28, a thickness Th2 in the optical axis direction OA changes from a start point portion 28a to an end point portion 28b. The thickness Th2 of the second inclined surface portion 28 decreases as the second inclined surface portion 28 extends to the first direction R1.

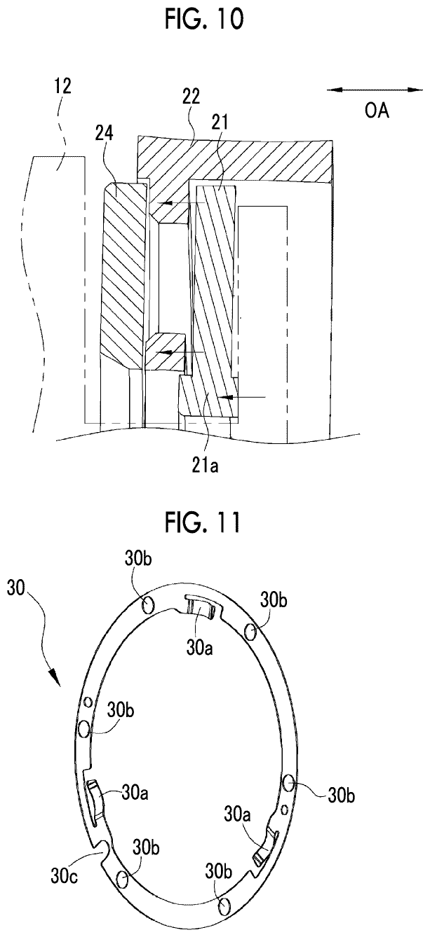

In a case where the locking member 22 is rotated in the first direction R1, the first inclined surface portion 26 and the second inclined surface portion 28 overlap each other along a radial direction of the locking member 22. In this case, the start point portion 28a of the second inclined surface portion 28 in the locking member 22 rotates while pressing the first inclined surface portion 26 of which the thickness Th1 increases as the first inclined surface portion 26 extends to the first direction R1. Accordingly, as shown in FIG. 9, the locking member 22 is moved to the first ring member 21 side in the optical axis direction OA to press the first ring member 21. In the first ring member 21, the bayonet claw 21a presses the lens barrel 12 in response to the pressing by the locking member 22. On the other hand, in a case where the locking member 22 is rotated in the second direction R2, the first inclined surface portion 26 and the second inclined surface portion 28 do not overlap each other along the radial direction of the locking member 22. Accordingly, as shown in FIG. 10, the locking member 22 is moved to the second ring member 24 in the optical axis direction OA, so that the pressing of the locking member 22 against the first ring member 21 is released. Accordingly, the pressing of the lens barrel 12 by the bayonet claw 21a is also released.

As described above, since the first ring member 21 is pressed by using the locking member 22, clearance in the optical axis direction OA with the lens barrel 12 side can be set to zero. Therefore, even in a case where the lens barrel 12 is enlarged and a force that causes the lens barrel 12 to be pulled out from the digital camera 10 is applied, a locking state with the lens barrel 12 is maintained. In addition, as will be described later, the lens barrel 12 is pulled in and held by a biasing portion 30a. However, even in a case where a moment force that causes the lens barrel 12 to be pulled out from the digital camera 10 is larger than a pulling force of the lens barrel 12 by the biasing portion 30a due to an increase in size of the lens barrel 12, the lens barrel 12 can be prevented from floating from the digital camera 10 by the pressing of the locking member 22 against the first ring member 21.

In addition, since the lens barrel 12 engages with the bayonet claw 21a of the mounting apparatus 13 and the lens barrel 12 can be temporarily held, it is not necessary to hold the lens barrel 12 by hand in a case where the locking member 22 is operated in the first direction R1. On the other hand, since it is not necessary to hold the lens barrel 12 by hand even in a case where the locking member is operated in the second direction R2, there is no risk of the lens barrel 12 falling off.

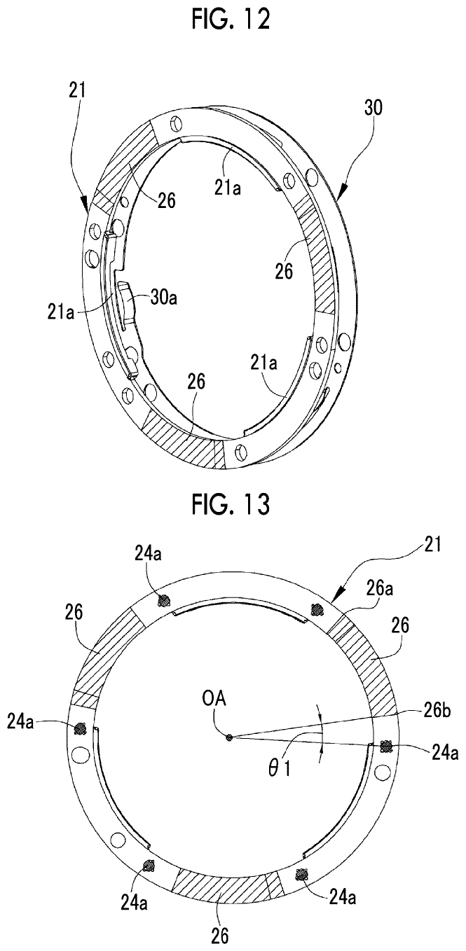

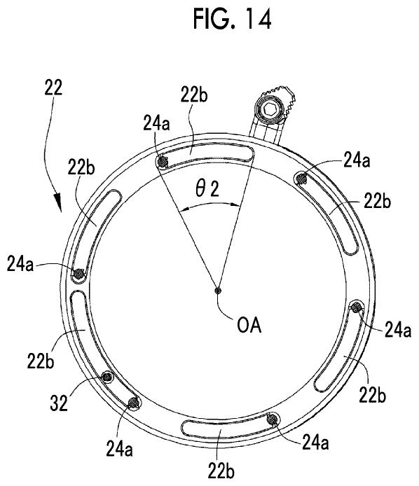

As shown in FIG. 11, the mounting apparatus 13 comprises a biasing ring 30 having the biasing portion 30a that biases the lens barrel 12 engaging with the first ring member 21. As shown in FIG. 12, three biasing portions 30a are provided at intervals of 120° between the first inclined surface portions 26 of the first ring member 21. The biasing portion 30a is a leaf spring, and in a case where the lens barrel 12 engages with the bayonet claw 21a, a bayonet claw engaging portion (not shown) of the lens barrel 12 is biased by the biasing portion 30a. In the biasing ring 30, an insertion hole 30b into which the coupling portion 24a of the second ring member 24 is inserted and a notch 30c into which a pin member 32 (see FIG. 14) is inserted are formed.

As shown in FIG. 13, an angle θ1 formed by the coupling portion 24a of the second ring member 24 and the first inclined surface portion 26 of the first ring member 21 is preferably within 15°. By setting the angle θ1 to be within 15°, deformation of the first ring member 21 and the second ring member 24 can be reduced during the pressing by the locking member 22.

As shown in FIG. 14, in the insertion hole 22b of the locking member 22, a stroke θ2 is set to be within 40° such that the stroke θ2 of the locking member 22 in the radial direction is set to be within 40°, and thus at least six points of the coupling portion 24a can be ensured, so that a coupling strength by the second ring member 24 can be ensured.

The pin member 32 that is movable in the optical axis direction OA and engages with the lens barrel 12 is also inserted into the insertion hole 22b. In a case where the pin member 32 abuts on the second ring member 24 at a start of mounting of the lens barrel 12, the pin member 32 is pressed to the camera body 11 side in the optical axis direction OA. Then, in a case where the lens barrel 12 engages with the bayonet claw 21a, the pin member 32 is moved to the lens barrel 12 side in the optical axis direction OA, and the pin member 32 engages with the lens barrel 12. Since the pin member 32 is biased toward the lens barrel 12 side in the optical axis direction OA, the engagement of the pin member 32 with the lens barrel 12 is maintained unless a pin release button 33 provided in the mounting apparatus 13 is operated.

Then, by operating the pin release button 33, the pin member 32 is moved to the camera body 11 side in the optical axis direction OA. Accordingly, the engagement of the pin member 32 with the lens barrel 12 is released, and the lens barrel 12 can be detached.

Next, a method of locking the lens barrel 12 (locking method) and a method of unlocking the lens barrel 12 (unlocking method) using the locking member 22 will be described. In a case where the lens barrel 12 is locked to the mounting apparatus 13, the lens barrel 12 is mounted and engaging with the bayonet claw 21a of the first ring member 21. In that state, by rotating the locking member 22 in the first direction R1, the lens barrel 12 engaging with the first ring member 21 is pressed in the optical axis direction OA of the lens barrel 12, so that the lens barrel 12 is locked. On the other hand, in a case where the locking of the lens barrel 12 is released, the pressing of the locking member 22 against the lens barrel 12 is released by rotating the locking member 22 in the second direction R2.

In the above-described embodiment, a case where the lens barrel 12 is mounted on the mounting apparatus 13 has been described. However other accessory devices may be mounted on the mounting apparatus 13. For example, as the accessory device, a mount adapter may be mounted on the mounting apparatus 13.

### EXPLANATION OF REFERENCES

10: digital camera
11: camera body
12: lens barrel
13: mounting apparatus
14: release switch
20: fixing member
21: first ring member
21a: bayonet claw
21b: insertion hole
22: locking member
22a: rotary lever
22b: insertion hole
24: second ring member
24a: coupling portion
24b: screw
26: first inclined surface portion
26a: start point portion
26b: end point portion
28: second inclined surface portion
28a: start point portion
28b: end point portion
30: biasing ring
30a: biasing portion
30b: insertion hole
30c: notch
32: pin member
33: pin release button
OA: optical axis
R1: first direction
R2: second direction

What is claimed is:

1. A mounting apparatus comprising:
a first ring member that engages with an accessory device in a case where the accessory device is mounted; and
a locking member that is rotatably supported, presses the first ring member engaging with the accessory device in an optical axis direction of the accessory device to lock the accessory device in a case where the locking member is rotated in a first direction, and releases the pressing in a case where the locking member is rotated in a second direction.

2. The mounting apparatus according to claim 1,
wherein the first ring member includes a plurality of first inclined surface portions of which thicknesses in the optical axis direction change,
the locking member includes a plurality of second inclined surface portions of which thicknesses in the optical axis direction change, and
in a case where the locking member is rotated in the first direction, the second inclined surface portion overlaps the first inclined surface portion along a radial direction of the locking member, so that the locking member is pressed in the optical axis direction.

3. The mounting apparatus according to claim 2,
wherein each of the first inclined surface portion and the second inclined surface portion is provided at three locations.

4. The mounting apparatus according to claim 2,
wherein in a case where the locking member is rotated in the first direction, a start point portion of the second inclined surface portion rotates while pressing against the first inclined surface portion, the thickness of which increases in the first direction.

5. The mounting apparatus according to claim 1,
wherein the first ring member includes a plurality of engaging portions engaging with the accessory device, and
the engaging portions press the accessory device by the pressing of the locking member against the first ring member.

6. The mounting apparatus according to claim 1, further comprising:
a biasing portion that biases the accessory device engaging with the first ring member,
wherein the biasing portion is provided between a plurality of first inclined surface portions in the first ring member, the thicknesses of which vary in the optical axis direction.

7. The mounting apparatus according to claim 1, further comprising:
a second ring member that includes a coupling portion for coupling the first ring member to be movable in the optical axis direction and coupling the locking member to be rotatable,
wherein the second ring member is fastened to a fixing member by a fastening member,
the first ring member includes a plurality of first inclined surface portions of which thicknesses in the optical axis direction change from a start point portion to an end point portion, and
an angle formed by the coupling portion and the end point portion of the first inclined surface portion is within 15°.

8. The mounting apparatus according to claim 1, further comprising:
a second ring member that includes a coupling portion for coupling the first ring member to be movable in the optical axis direction and coupling the locking member to be rotatable,
wherein an insertion hole into which the coupling portion is inserted is formed in the locking member along a radial direction of the locking member.

9. The mounting apparatus according to claim 8,
wherein the insertion hole is formed such that a stroke of the locking member in the radial direction is within 40°.

10. The mounting apparatus according to claim 1, further comprising:
a pin member that is movable in the optical axis direction and engages with the accessory device.

11. The mounting apparatus according to claim 10, further comprising:
a second ring member that includes a coupling portion for coupling the first ring member to be movable in the optical axis direction and coupling the locking member to be rotatable,
wherein an insertion hole into which the pin member and the coupling portion are inserted is formed in the locking member along a radial direction of the locking member.

12. An imaging apparatus comprising:
the mounting apparatus according to claim 1.
